(19) United States
(12) Patent Application Publication
(10) Pub. No.: US 2011/0042958 A1
(43) Pub. Date: Feb. 24, 2011

(54) COLLAPSIBLE VERTICAL-AXIS TURBINE

(75) Inventor: Roland J. VANDER STRAETEN, Tornoto (CA)

Correspondence Address: MILLER THOMPSON, LLP, Scotia Plaza, 40 King Street West, Suite 5800, TORONTO, ON, M5H 3S1, CA

(73) Assignee: Vaxsis Inc., Toronto (CA)

(21) Appl. No.: 12/528,863

(22) PCT Filed: Feb. 27, 2008
(86) PCT No.: PCT/CA2008/000358

§ 371 Date: Apr. 19, 2010

(30) Foreign Application Priority Data
Feb. 27, 2007 (US) 60891737

(51) Int. Cl. F03D 3/00; F03D 9/00; F03D 11/04

(52) U.S. Cl. 290/55; 416/142

(57) ABSTRACT

A collapsible vertical-axis turbine for wind or hydro applications is provided, comprising a plurality of vertical blades hingedly connected to a plurality of support arms, a tower having a rotating section, the rotating section hingedly connected to the plurality of support arms. In operating mode, the support arms achieve a substantially horizontal position in the operating mode, and in a collapsed mode the plurality of vertical blades preferably nest substantially adjacent and substantially parallel to the tower. A cable means is provided for erecting the vertical blades into an operating mode. The disclosed configuration is easy to erect and collapse for transport, and is well-suited to be implemented as a small to medium scale turbine for deployment to remote locations.

### FIELD OF THE INVENTION

The present invention relates to wind and/or hydro turbine technology. The present invention more particularly relates to vertical-axis turbines.

### BACKGROUND OF THE INVENTION

Wind energy remains as one of the most promising renewable energy resources available. It is abundant, inexhaustible, widely distributed and clean. Because of these attributes, there continues to be intensive interest and research in harvesting wind energy.

In essence, a wind energy system, such as a wind turbine, transforms the kinetic wind energy into electrical or mechanical or energy that can be harnessed for practical use. There are numerous existing wind turbine configurations. Some are hundreds and perhaps even thousands of years old. Old “windmill” technology used wind energy to turn mechanical machinery to carry out physical work, like crushing grain or pumping water. Modern turbine technology operates by converting kinetic energy from the rotation of turbine blades into electrical energy through the use of an electrical generator.

Wind turbines come in many sizes, shapes and configurations, and have power ratings ranging from 250 watts to 5 megawatts. Generally speaking, two basic turbine design types have emerged: vertical-axis (including “egg-beater” or Darrieus-type, having curved airfoils) and horizontal-axis (propeller). The horizontal-axis wind turbines are the most common, constituting nearly all of the larger scale implementations in the global market.

Despite being less popular, a vertical-axis turbine arrangement has a number of general advantages over horizontal-axis turbines. These include:
in a vertical-axis turbine, the generator can be placed at the ground level for easy servicing;
the main supporting tower may be relatively light because of lesser transverse wind forces;
vertical-axis designs do not require specific positioning based on wind direction; and
“Pitching” of the vertical blades, i.e. altering the airfoil blade pitch to improve efficiency, is often not required.

Wind turbines are currently used to generate electricity for various uses, including for homes and communities, businesses, and for sale back to utility grids. Vertical-axis turbines are well-suited for smaller or remote applications to provide electricity where infrastructure is lacking.

There have been some notable developments in the field of vertical-axis wind turbines. For example, Dery et al. in U.S. Pat. No. 6,979,170 and U.S. Patent Application No. 2004/0120820 describe a self-erecting vertical-axis windmill and method. However, the configuration taught therein is relatively complicated and only provides a means for the tower self-erect, and not the blade structure.

U.S. Pat. No. 4,624,624 to Yum describes a collapsible vertical wind mill having four wings. However, one of the drawbacks is that the wings are arranged in a rhombic formation, with the result that they create modest wind leverage. Further, the device when collapsed is not compact to facilitate transportation.

In addition to harvesting wind energy, vertical-axis turbines have been implemented in extracting energy from the sea. Several of these hydro turbine devices have been proposed, for example, the DAVIS™ turbine by Blue Energy Canada Inc., or the KOBOLD™ turbine by Ponte di Archimede S.p.A. However, these devices do not feature collapsibility to allow for easy transport.

In view of the foregoing, what is needed is a vertical-axis turbine that is easy to erect, collapse and transport.

### SUMMARY OF THE INVENTION

In one aspect, the present invention provides a collapsible vertical-axis turbine including a tower having a rotating section, the rotating section hingedly connected to a plurality of support arms, a plurality of vertical blades hingedly connected to the plurality of support arms. In operating mode, the support arms achieve a substantially horizontal position in the operating mode, and in a collapsed mode the plurality of vertical blades preferably nest substantially adjacent and substantially parallel to the tower.

In another aspect, the present invention provides a cable means for erecting the vertical blades of the collapsible vertical-axis turbine to an operating mode. In one embodiment, the cable means is a cable system including a winch and a pulley, with the winch and the pulley centrally located on the rotating section of the tower.

The collapsibility of the turbine of the present invention advantageously allows for the turbine to be erected/collapsed for installation, required maintenance, due to high wind conditions, etc. The turbine of the present invention is relatively inexpensive and, because it is easy to erect and collapse, is ideally suited for deployment in remote locations.

### BRIEF DESCRIPTION OF THE DRAWINGS

A detailed description of an embodiment is provided herein below by way of example only and with reference to the following drawings, in which:

FIG. 1 illustrates a wind turbine erected in operation mode in accordance with the present invention;

FIG. 2A illustrates a collapsed wind turbine;

FIG. 2B illustrates a wind turbine in an intermediate configuration;

FIG. 3A and FIG. 3B are side views of a turbine in operation mode and in an intermediate configuration, respectively, illustrating further detail;

FIG. 4A and FIG. 4B are a top view and a side view, respectively, of a supporting arm joining the ring with the pin engaged (operation mode);

FIG. 5A and FIG. 5B are a top view and a side view, respectively, of a supporting arm joining the ring with the pin disengaged (collapsed mode);

FIG. 6 illustrates a potentional/possible position for the winch;

FIG. 7 illustrates a potentional/possible position for the lever for use as a secondary system; and

FIG. 8 is a top view of a turbine.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The present invention is directed at a collapsible vertical-axis turbine for wind or hydro applications. The configuration disclosed herein allows for the transport, installation, operation and maintenance (including cleaning) of a small to medium turbine, suitable for “remote” locations where some of the infrastructure to meet these activities is lacking, especially since no cranes are required.

Advantageously, the present invention also allows the turbine to collapse for either transportation or in cases of inclement weather, when necessary, when there are strong winds that could potentially damage the turbine, as in hurricane conditions. The usefulness of this innovation increases with the size of the turbine, with the lower range being a turbine that generates about 250 W of power.

The present invention is preferably implemented in a wind turbine (as illustrated in the drawings) capable of generating 250 W to 1 MW of electricity, and having a tower height of 2 to 120 m. However, other embodiments are possible, and it should be understood that the present invention includes implementing the turbine underwater as a hydro power generator.

As discussed above, vertical-axis turbines have many variants. However, to enable easy transport to the site, the present invention provides a vertical-axis turbine having essentially straight blades. There are a number of advantages to having a vertical-axis configuration, including: (i) blades can be straight do not need to be pitched, so they are generally less expensive to make; (ii) the system does not have to move according to wind direction; and (iii) the turbine design as a whole is generally less complicated and therefore less expensive to manufacture. Furthermore, a vertical-axis wind turbine that is collapsible allows for easy transportation, and the collapsibility is advantageous in avoiding storm damage.

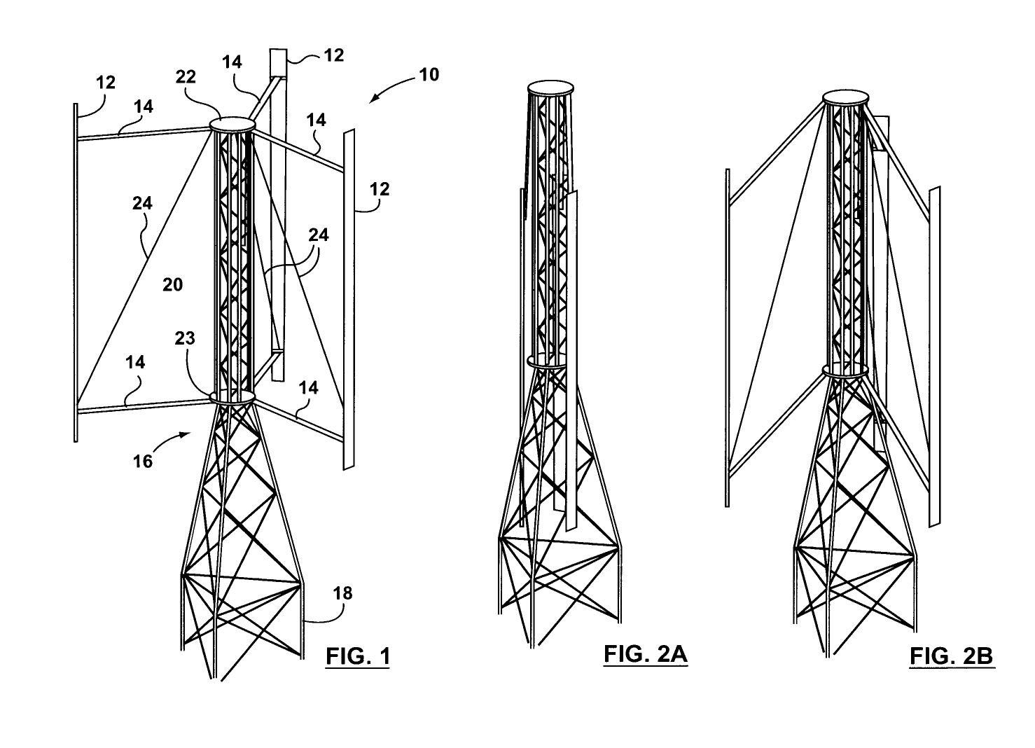

An embodiment of the present invention is shown in FIG. 1, which illustrates a collapsible vertical-axis wind turbine 10 erected in an operation mode. The turbine 10 comprises airfoils or blades 12 connected to blade support arms 14, which are in turn connected to a rotating section or hub 20 supported by a stationary tower 16, the tower 16 having a base 18. The hub 20 has an upper ring 22 and a lower ring 23. The blades 12 are supported by the arms 14 and cables 24, as discussed below. Preferably and advantageously, the gearbox and generator (not shown) are located at the ground level to allow easy access, e.g., for maintenance.

In order to keep the overall weight of the system down, it is preferable that the blades 12 are fabricated from a light but strong material. For example, the blades 12 could be fabricated by fibreglass pultrusion. Similarly, the tower 16 could be designed as a lattice structure of either steel or aluminium.

FIG. 2A shows the turbine 10 in a collapsed mode, e.g., ready for transport. In this mode, the blades 12 reside advantageously alongside the periphery of the tower 16, thereby minimizing the transport size of the turbine 10. FIG. 2B shows the same wind turbine in an intermediate configuration.

The collapsed state allows the turbine 10 (when implemented as a wind turbine) to better withstand strong winds during a storm. In addition, it is possible to have a maintenance platform (not shown) travel up and down along the length of the tower 16, depending on the height of the tower 16.

The tower 16 is shown as having a triangular cross-section, but it should be understood that it can take one of any number of shapes, as would be recognized by one skilled in the art. Further, although the figures depict a turbine 10 having three blades 12, it should be understood that the present invention contemplates any number of blades, but preferably two to six. Moreover, although the figures illustrate two horizontal support arms 14 located at the top and bottom of the hub 20, any number of intermediate supports could be included.

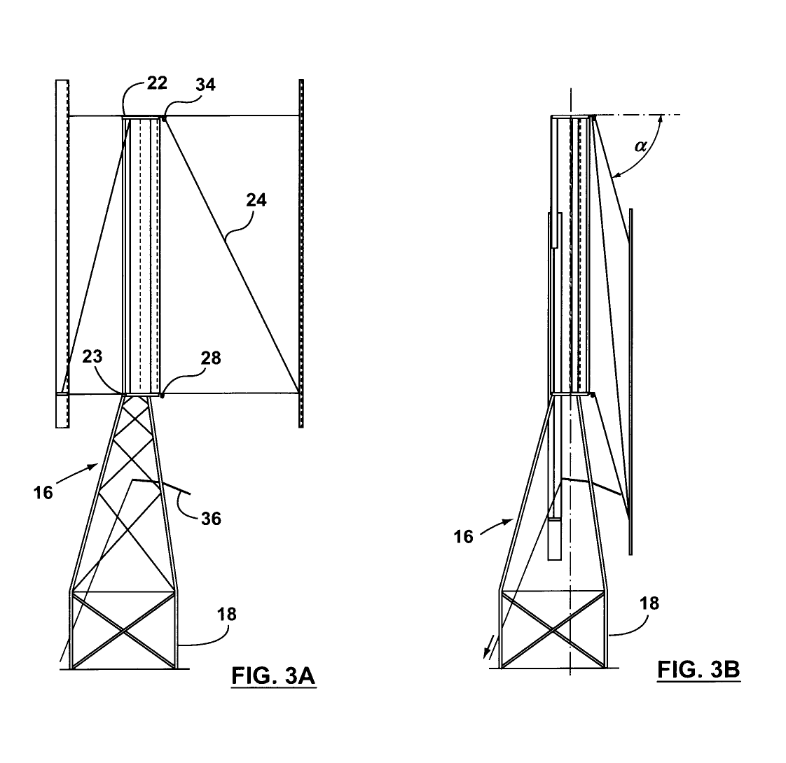

FIG. 3A and FIG. 3B illustrate an embodiment of the present invention in further detail. The turbine 10 includes a cable system, the cable system comprising winches 28, pulleys 34 and a cable 24, the cable being attached to the blades 12 at a connection point toward the bottom of the blade 12. The cable system provides the primary means for erecting and collapsing the support arms 14 and blades 12. In particular, the winches 28 pull or release the cables 24, thereby erecting or collapsing the support arms 14 and blades 12.

Optionally, a secondary system means for erecting and collapsing the support arms 14 and blades 12 may be provided, the secondary means including a lever 12 positioned in the tower 16, discussed below.

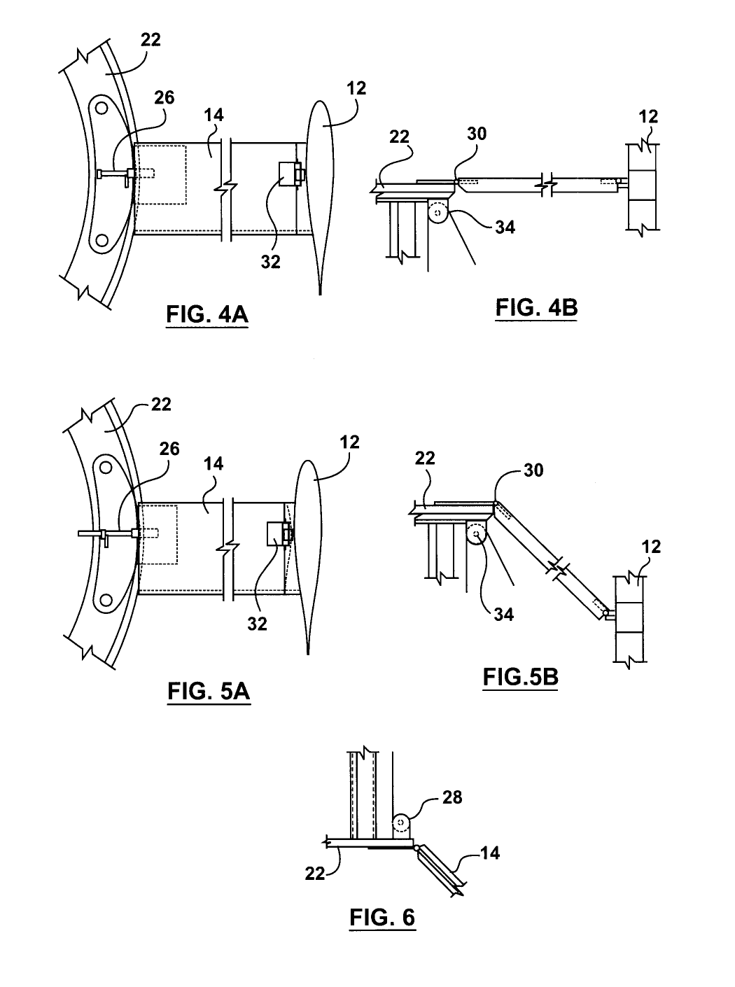

As shown in FIG. 4A and FIG. 4B, the support arms 14 are connected to the upper ring 22 via an inner hinge and hinge pin 30 that may be located at or near the end of the support arm 14. The support arms 14 are connected to the lower ring 23 in the same manner. The support arms 14 are connected to the blades 12 via an outer hinge and hinge pin 32.

A locking pin 26 in the top ring 22 is preferably engaged for security when the turbine 10 is in the operating mode. Depending on the loads on and flexibility of the various components of the turbine 10, the locking pin 26 and its engaging mechanism could be replicated for all upper and lower support arms 14, as well as on the lower ring 23.

As shown in FIG. 5A and FIG. 5B, when the locking pin 26 is disengaged, the support arm 14 is free to rotate about the inner hinge and hinge pin 30. The blade 12 is free to rotate about the outer hinge and hinge pin 32. Thus, it should be understood that the configuration composed of arms 14, blade 12 and hub 20 forms a parallelogram when viewed from the side, and the blades 12 are generally maintained in substantially vertical orientation and preferably parallel to the tower 16.

The cable system, comprising winches 28, pulleys 34 and a cable 24, controls the angle of the arms 14 in the case of disengagement of the locking pin 26. A potential/possible position for the winch 28 is shown in FIG. 6.

It should be understood that although this embodiment features a cable system having a winch 28 and a pulley 34, the present invention is not limited to these particular components but includes variants achieving the same function, as would be recognized by one skilled in the art.

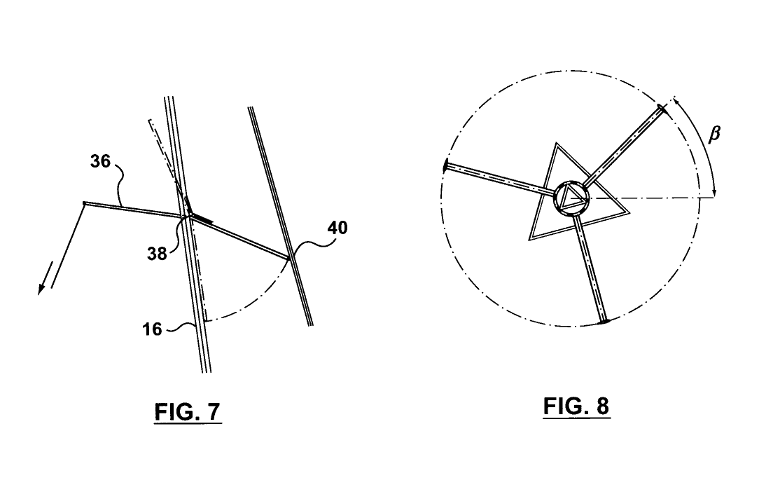

According to a further aspect of the present invention, depending on the turbine 10 configuration, particularly its weight, and even more particularly the weight of the arms 14 and blades 12, the cable system can be used for this purpose only until the angle α (shown in FIG. 3B) reaches a specific threshold value. At this point, the leverage required by pulling/releasing the cables may be too great for a winch. Therefore, further erecting/collapsing of the rotor can be accomplished by a secondary system. This secondary system, according to an embodiment, comprises a lever 36 that pivots around pivot point 38, the pivot point 38 located on the tower 16 as illustrated in FIG. 7. The lever 36 can be operated either manually or using an automated system simply by attaching a cable or rope to its end, as shown. The geometry of the lever 36 is such that it makes contact with a lower support arm 14 when α reaches the specific value. At that point the position of the lever 36 is in an “open” position. There are several possible extensions to this secondary system. As an example, the lever 36 could be designed such that its natural position is in the “open” position. Further, the addition of a damper to the secondary system will ensure safety in case cable 24 should break. Each of the blades 12 preferably has a lever 36 associated with it.

To avoid any interference with the tower 16 having a triangular horizontal cross-section, including its lattice work (if any), and to ensure proper interface with the levers 36, the locking pins 26 are engaged with the upper and lower rings 22, 23 such that the locking pins 26 can only disengage when the position of the arms 14 and blades 12 relative to the tower 16 reaches an angle of approximately equal to β as illustrated in FIG. 8. β is a predefined value and dependent on specific configuration of the wind turbine 10. The engagement and disengagement of locking pins 26 can be achieved mechanically as well as electrically, as would be appreciated by a person of skill in the art. This secondary system may be incorporated in the support arm 14 if the hinge pin 30 is located some distance from the inner end of the support arm 14.

It will be appreciated by those skilled in the art that other variations of the preferred embodiment may also be practised without departing from the scope of the invention.

What is claimed is:

1. A collapsible vertical-axis turbine comprising:
(a) a tower having a rotating section, the rotating section hingedly connected to a plurality of support arms; and
(b) a plurality of vertical blades hingedly connected to the plurality of support arms.

2. The turbine of claim 1 wherein the support arms achieve a substantially horizontal position in an operating mode.

3. The turbine of claim 1 wherein in a collapsed mode the plurality of vertical blades nest substantially adjacent and substantially parallel to the tower.

4. The turbine of claim 1 further comprising a cable means for erecting the vertical blades into an operating mode.

5. The turbine of claim 1 wherein there are two to six vertical blades.

6. The turbine of claim 1 wherein each vertical blade is hingedly connected to an upper support arm and a lower support arm.

7. The turbine of claim 6 wherein the rotating section comprises an upper ring and a lower ring, wherein the upper ring is hingedly connected to the upper support arm and the lower ring is hingedly connected to the lower support arm.

8. The turbine of claim 7 further comprising one or more locking pins engaged when in operating mode.

9. The turbine of claim 8 wherein the one or more locking pins are located on the upper ring or lower ring.

10. The turbine of claim 8 wherein the tower has three faces defining a triangular horizontal cross-section, and the one or more locking pins are disengageable when the vertical blades are positioned centrally to the faces.

11. The turbine of claim 10 wherein engagement or disengagement of the one or more locking pins is achieved by mechanical or electrical means.

12. The turbine of claim 4 wherein the cable means is a cable system, the cable system comprising:
(a) pulley means located on upper positions of the rotating section;
(b) winch means; and
(c) cables attached to connection points located on lower portions of each vertical blade;
wherein the cables run from the first connection points through the pulley means to the winch means.

13. The turbine of claim 12 wherein the winch means are located on lower positions on the rotating section.

14. The turbine of claim 12 further comprising a secondary system, the secondary system including levers for positioning the plurality of support arms.

15. The turbine of claim 1 operable to generate 250 W to 1 MW.

16. The turbine of claim 1 wherein the tower is 2 to 120 meters in height.

17. A collapsible vertical-axis turbine, the turbine comprising:
(a) vertical blades, each vertical blade having an upper portion hingedly attached to a first end of an upper support arm and each vertical blade having a lower portion hingedly attached to a first end of a lower support arm;
(b) a rotatable hub supported by a stationary tower, the rotatable hub having an upper section hingedly attached to a second end of the upper support arms and the rotatable hub having a lower section hingedly attached to a second end of the lower support arms; and
(c) a cable system including cables connected to the lower portions of the vertical blades, the cables running through pulleys located on about the upper section of the rotatable hub, and the cables connected to winches;
wherein the winches are operable to pull the cables to erect the turbine such that the upper support arms and the lower support arms achieve a substantially horizontal position, and wherein the winches are operable to release the cables to collapse the turbine.

18. The collapsible vertical-axis turbine of claim 17 wherein the winches are located on the lower section of the rotating hub.

19. The collapsible vertical-axis turbine of claim 17 operable to generate 250 W to 1 MW.

20. The collapsible vertical-axis turbine of claim 17 wherein the tower is 2 to 120 meters in height.
